(19) United States
(12) Patent Application Publication
(10) Pub. No.: US 2013/0318486 A1
(43) Pub. Date: Nov. 28, 2013

(54) METHOD AND SYSTEM FOR GENERATING VERIFICATION ENVIRONMENTS

(71) Applicant: Lawrence SASAKI, Oxford Station (CA)

(72) Inventor: Lawrence SASAKI, Oxford Station (CA)

(21) Appl. No.: 13/889,544

(22) Filed: May 8, 2013

Related U.S. Application Data
(60) Provisional application No. 61/650,658, filed on May 23, 2012.

(51) Int. Cl. G06F 17/50

(52) U.S. Cl. CPC G06F 17/5045
USPC 716/106

(57) ABSTRACT

A method and system for a verification of a DUT is provided. The method and system is configured to generate a verification environment using a rules based metalanguage. The rules are converted into components in the verification environment. The method and system is configured to, for example, generating constraints in transactions and coverpoints in the coverage model; coupling coverage to requirements by ruleid instead of coverage; implement automatic generation, implement checking and coverage of errored transactions; and integrate algorithmic stimulus generation along with constrained random stimulus.

### FIELD OF INVENTION

The present invention relates to hardware design verification, and more specifically, to a method and system for verification of a design under test (DUT).

### BACKGROUND OF THE INVENTION

The development and verification of electronic circuits in the Electronic Design Automation (EDA) domain is well established especially concerning the verification of circuits implemented using Hardware Design Languages (HDLs), such as Verilog and VHDL. These languages allow designers to describe circuits at the register transfer level. Using such languages, designers can implement circuits comprising millions of transistors. Circuits of such complexity need to be completely verified before being committed to silicon.

Design verification is the process used to verify the operation of such circuits in the EDA. Verification of such circuits is done in different domains, each tool examining a different aspect of the design. These domains include: static with such concerns as timing analysis and CDC (clock domain crossing); quasi-static with such methods as formal verification where the inputs and outputs of the circuit as described using assertions and the circuit is verified mathematically; and temporal using circuit simulators.

Temporal verification techniques are varied, but all use the same basic method. First an environment is created in which the device under test (DUT) is placed; the environment consists of a harness which connects the DUT to the rest of the environment. The rest of the environment is implemented in a variety of languages including Verilog, SystemVerilog, VHDL and SystemC. Tests are written which generate specific stimulus and performs specific checks. Each test verifies specific aspects of the design according to a testplan and a set of specifications.

With the growing complexity of design circuits, the verification methodologies have evolved to the next level where tests are written by the environment and the environment performs all checks. The most recent and popular is the Constrained Random verification methodology using specific implementation methodologies such as Synopsys VMM, open source Open Verification Methodology (OVM), Universal Verification Methodology (UVM), etc. The flow for the Constrained Random verification is disclosed in US Patent Application Publication No. 2004/0216023 by Maoz et al. In this flow, tests are generated using specific facilities provided by the verification languages. These languages include features such as constraint driven randomization for stimulus generation, algorithmic expressions for checking, and functional coverage to report on both the stimulus generated by the testbench and the responses generated by the DUT.

Even with such an array of tools, the amount of effort expended verifying design circuits often far exceeds the effort to design them. Design is concerned with describing the implementation of the circuit in a HDL. Concerns include: normal operation, different operating modes, the handling of erroneous input. Verification must handle all of these concerns. It must ensure that all different stimulus and scenarios are generated; it must verify that the DUT performs its operation according to the specification; it must measure and report all activity in the environment. These three aspects of the verification process employ different implementations. Generation is done using transactions coupled with sequences. Checking is done by checking components in the environment. Reporting is done using coverage which is linked back to the testplan. Once the coverage is linked to the testplan, the testplan is updated using software that links the coverage values in a database to the testplan to produce a coverage result. Such a testplan is called an Executable testplan and the total testplan coverage is the metric which is used over raw coverage. The testplan is most often in a spreadsheet to facilitate the back annotation of the plan with coverage data.

One issue in the conventional systems is that the development of these different views is done manually in accordance with the Testplan and Design Specifications. One architectural aspect that needs to be carefully considered is the split between how complex the transactions within the components need to be and how much complexity is embodied in the sequences that generate the transactions. Stimulus is split between the transactions associated with the components and sequences that generate streams of transactions. Each sequence generates transactions by randomizing them. If the transaction is not complex enough, more effort is required by the sequence to ensure the generation of valid stimulus.

Another issue is that the best coverage is not obvious whereas manually created coverage focuses on what is obvious. Also the process of linking coverage to the testplan is time consuming and error prone.

Another issue is the handling of error scenarios: the generation of errored stimulus, the checking of the behavior of the DUT to the errored stimulus and the coverage of both the stimulus and response of the DUT, are again all a manual process. These must be planned and executed in accordance with the testplan.

Another issue with the current methodology is closing the process. Being stochastic in nature, coverage increases as more tests are run. It is easy to get coverage to 70%, but more difficult to get to levels of 90-95%. Coverage grows asymptotically to 100% which can never be achieved with the random testbench. To close at 100% coverage, the verification team needs to write directed tests to ensure the generation of desired stimulus. To ameliorate this, various levels of testbench automation are introduced. One such tool is disclosed in US Patent Application Publication No. 2005/0071720 by Kadkade et al. which uses an algorithmic approach based on rules. The rules provide an abstraction of the specification which then are used to generate the stimulus. Being algorithmic, tests linearly acquire 100% coverage.

### SUMMARY OF THE INVENTION

It is an object of the invention to provide a method and system that obviates or mitigates at least one of the disadvantages of existing systems.

According to an aspect of the present invention there is provided a method of generating a verification environment, which includes: at least one of describing, organizing, analyzing and receiving a set of rules with a metalanguage, for verifying performance of a design under test (DUT); and converting the rules written in the metalanguage to verification code implementing the verification environment operably coupling to the DUT.

According to a further aspect of the present invention there is provided a computer readable storage medium storing one or more programs, the one or more programs comprising instructions, which when executed by a computer device, cause the computer device to perform a method of generating a verification environment, the method including: at least one of describing, organizing, analyzing and receiving a set of rules with a metalanguage, for verifying performance of a design under test (DUT); and converting the rules written in the metalanguage to verification code implementing the verification environment operably coupling to the DUT.

According to a further aspect of the present invention there is provided a system for generating a verification environment, which includes: a rules file comprising a set of rules written in a metalanguage to describe the verification environment for verifying performance of a design under test (DUT); and a translator for converting the rules written in the metalanguage to verification code implementing the verification environment operably coupling to the DUT.

According to a further aspect of the present invention there is provided a system for generating a verification environment, which includes: a processor; and a computer readable storage medium storing one or more programs, the one or more programs comprising instructions, which when executed by the processor, cause the processor to: convert rules in a rules file written in a metalanguage to verification code implementing the verification environment operably coupling to a design under test (DUT).

According to a further aspect of the present invention there is provided a system for generating a verification environment, which includes: a processor; and a computer readable storage medium storing one or more programs, the one or more programs comprising instructions, which when executed by the processor, cause the processor to: describe, organize or receive a set of rules in a rules file written in a metalanguage to verification code implementing the verification environment operably coupling to a design under test (DUT); and analyzing the set of rules.

According to a further aspect of the present invention there is provided a method for verification of a design under test (DUT), which includes: analyzing rules written in a metalanguage to convert the rules into verification code implementing a verification environment operably coupling to the DUT; and linking the verification code to algorithmic test generation.

According to a further aspect of the present invention there is provided a computer readable storage medium storing one or more programs, the one or more programs comprising instructions, which when executed by a computer device, cause the computer device to perform a method for verification of a design under test (DUT), the method including: analyzing rules written in a metalanguage to convert the rules into verification code implementing a verification environment operably coupling to the DUT; and linking the verification code to algorithmic test generation.

### BRIEF DESCRIPTION OF THE DRAWINGS

These and other features of the invention will become more apparent from the following description in which reference is made to the appended drawings wherein:

FIG. 1 is a schematic diagram illustrating an example of a system for generating a verification environment for verification of a DUT;

FIG. 2 is a flow diagram illustrating a conventional Constrained Random Flow;

FIG. 3 is a flow diagram illustrating one example of a Constrained Random Flow by using the system shown in FIG. 1;

FIG. 4 is a schematic diagram illustrating an example of verification architecture with the system and DUT shown in FIG. 1;

FIG. 5 is a schematic diagram illustrating an example of a translator shown in FIGS. 1 and 4.

### DETAILED DESCRIPTION

Verification has evolved from the pin-based ATE (Automated Test Equipment) level where stimulus was defined using 1's and 0's. It next used test harnesses coupled to generators and checkers driven by specific stimulus embodied in tests. The tests were written manually. This next level of abstraction describes how tests are to be written, and the environment generates the tests and stimulus.

The embodiments of this disclosure provide a method and system for generating a verification environment and/or using components in the verification environment for the successful verification of a DUT. In the description, the terms “component(s)”, “model(s)”, “element(s)”, and “module(s)” may be used interchangeably.

According to the embodiments of this disclosure, the method and system is configured to put verification on par with design. This is contrast that conventional verification requires about 2-3 times the effort of design. The method and system according to the embodiments of this disclosure is configured to generate the different views of components in a verification environment by using a declarative, rules based metalanguage. A set of rules written in the declarative, rules based metalanguage is direct-translated to components that are applied to a DUT to verify the implementation of a specific protocol or design architecture. Since the description is rules based, there is only one source that describes the component. The concept of the rules for generating the verification environment resides in the declarative domain. Here the declarative language defines the set of rules which are met to produce a given result for a specific protocol or design. Each rule is a declaration of validity. This is different from a procedural language in that a procedural language defines actions based on procedural statements such as loop, while, assign, etc. statements.

In a non-limiting example, the method and system is configured to generate at least a part of testbenchs (e.g., constrained random testbenches), OVM components (OVCs), UVM components (UVCs), and/or non-temporal components. The generated components may be derived from or linked to the OVM base class/library.

In a non-limiting example, the method and system is configured to translate the description in the metalanguage to a target language to work with the target language, such as a HDL and high-level verification language (e.g., SystemVerilog, VHDL, SystemC).

In a non-limiting example, the method and system is configured to at least one of: direct map rules to requirements for a resultant product to simplify the creation of an executable testplan; generate at least one constraint for variables for a constrained random simulation; generate at least one of components for checking and collecting coverage information for a specific design, e.g., such that they are complete with appropriate levels of complexity in transactions and coverage models; link at least a part of the generated components to an algorithmic component (e.g., a stimulus engine for generating stimuli); separate stimulus generation and checking; and simplify error handling. Using the rules based metalanguage allows for integration with a rules based algorithmic stimulus generation giving an integrated random/directed environment for verification.

It would be appreciated by one of ordinary skill in the art that a declarative language embodies statements in the specification using expressions. They do not include assign statements so the modification of variable values is not part of the language. Also declarative languages tend to be non-temporal whereas the verification environment is inherently temporal. Here the system generates non-temporal verification code used by the components which transforms it to operate in the temporal domain. This is different from US Patent Application Publication No. Publication 2010/0218149 by Sasaki where the rules would be compiled into code that would be interpreted by special verification automata to perform verification activity which is inherently temporal in nature.

An example of a temporal aspect that is difficult to verify in a declarative manner is that of a request-response protocol. In such a protocol, requests are generated to which responses are returned; the environment must check that the proper response has been returned to the requestor when it can be further checked in detail by generated, non-temporal code. Other temporal based components need to be created manually to provide an infrastructure that can be controlled by rules. This is a task that verification engineers tend to thrive on, whereas the tasks of creating a complete set of constraints and a comprehensive coverage model tend to be deferred requiring a lot of later rework. The knock on effect is the continual updating of the Executable Testplan with new coverage information.

Using the rules based approach, many of the manual tasks can be automated. In a non-limiting example, there is a one-to-one correspondence between requirement and rule. Thus the executable testplan can be generated as opposed to manually annotated; once generated it can be updated to include weight and goal information which is used to tune the testplan coverage result. Since transactions are automatically generated, they include a comprehensive set of constraints; these allow tests to be simpler since the transaction does most of the work. The process of error handling can be automated by the inclusion of error directives into the rules for the generation and checking of invalid stimulus; this relieves the verification engineer of the task of manually verifying the DUT's error handling capabilities.

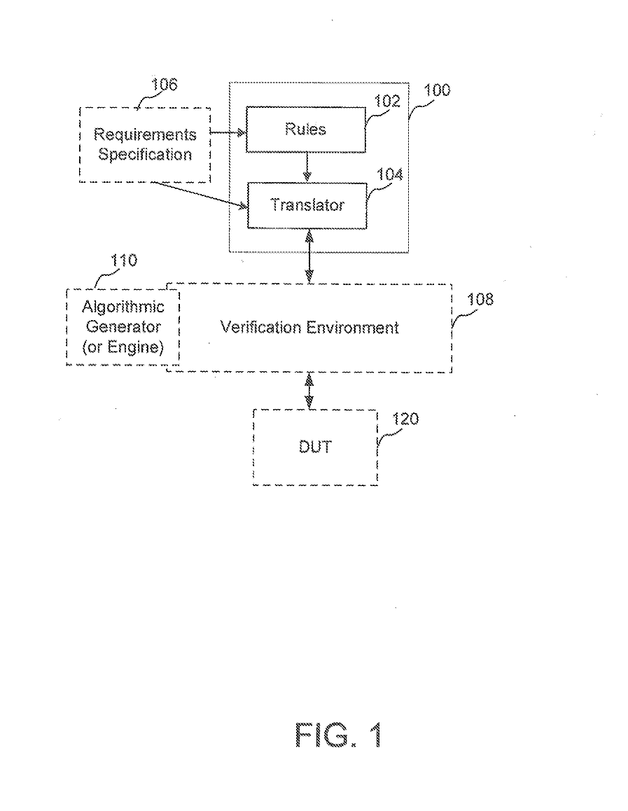

Referring to FIG. 1, there is illustrated verification architecture with a system 100 for generating a verification environment applied to a DUT 120. The system 100 includes a rules file 102 having a set of rules for each design and a translator 104 for analyzing and converting the set of rules. The system 100 is implemented in a computer system having a processor and a memory, which may be controlled by one or more main processing cores that are, for example, a microcontroller or a digital signal processor (DSP).

In FIG. 1, the system 100 and its environment are illustrated for example purposes only. The system 100 may include elements not shown in FIG. 1, for example, but not limited to a user interface and/or an editor for editing or creating the rules file 102, such as vim, and/or a database. The system 100 may include an indicator for indicating the analyzed results or errors in the set of rules to the user. An analyzer for analyzing the rules in the rules file 104 may be implemented as a separate component from the translator 104.

A set of rules associating with requirements for a target design is organized in the file 102. The set of rules may be organized outside the system 100 and transmitted to the rules file 102 or translator 104. Here the rules in the rules file 102 is written by a declarative, rules based metalanguage. The metalanguage is used to describe the verification environment 108 (or verification code 108) under which verification is conducted. The translator 104 converts the rules in the rules file 102 into the verification environment 108 such that the DUT 120 interacts with the generated verification environment 108.

The rules file 102 is linked to a requirements specification 106 for specifying a target hardware, via a rule identification (herein referred to as “ruleid”). Using the ruleid, there establishes direct mapping of the rules to the requirements. In a non-limiting example, the requirements specification 106 is converted to a target Executable testplan format via the rules. The direct mapping between the rules and the requirements simplifies the creation of the Executable testplan.

The translator 104 is configured to translate the description in the metalanguage to the chosen target language for implementing the verification environment. In a non-limiting example, a target language is SystemVerilog or SystemC using an existing methodology such as OVM or UVM.

In a non-limiting example, the translator 104 converts rules in the file 102 into the verification code 108 which includes at least one of: code for generating a set of constraints for variables that can be randomized, for constrained random simulation; code for checking the DUT 120 outputs; code for generating a coverage model; and/or code for error handling. The components generated from the rules file 102 include, for example, but not limited to, a transaction, a sequencer, a driver, a monitor, a coverage, a checker, an interface, and/or a response handler, as described below. In a non-limiting example, the rules file 102 is configured so that the verification environment 108 interacts with another algorithmic engine 110. In a non-limiting example, the rules file 102 is configured to independently support stimulus generation and response checking. In a non-limiting example, the rules file 102 is configured to support automatic handling of errors, including error injection of the stimulus and error checking and reporting of the response.

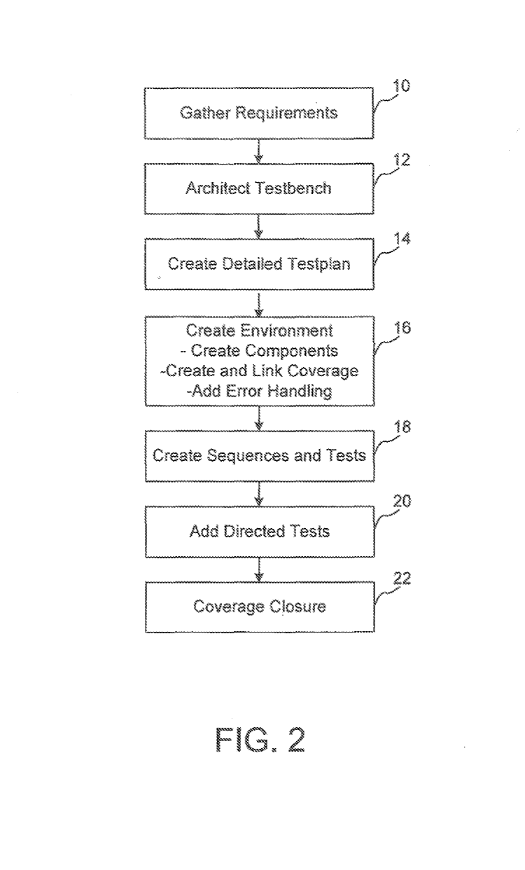

Referring to FIG. 2, there is illustrated a conventional Constrained Random flow. The Constrained Random of FIG. 2 includes a plurality of tasks including: gathering requirements for verification of a DUT (10), architecting suitable testbench (12); manually creating a detailed testplan (14); manually creating verification environment (16) including creating components, creating and linking coverage to the testplan and adding error handling; manually creating sequences and tests (18); adding directed tests (20) that run on the DUT; and based on the DUT's outputs, achieving coverage closure (22). Here in the conventional Constrained Random testing of FIG. 2, the tasks 10-22 includes a number of manual tasks 14, 16, 18, and 20.

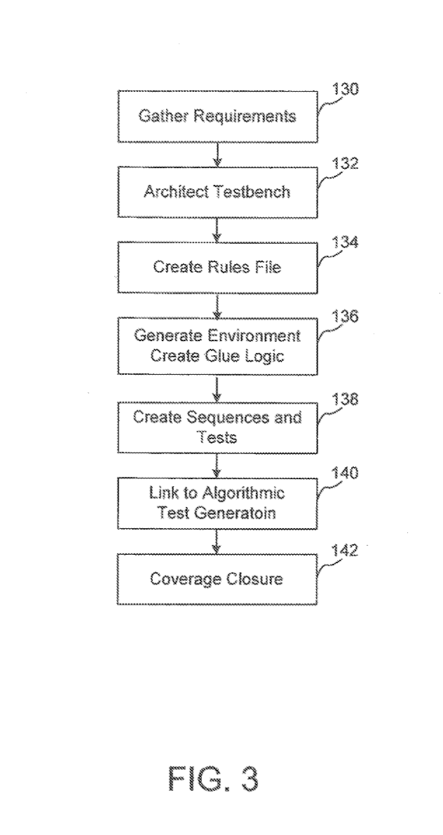

Referring to FIG. 3, there is illustrated an example of a verification flow by using the system 100 of FIG. 1. The verification flow shown in FIG. 3 includes a plurality of tasks including: gathering requirements (130) for verification of a DUT; architecting a testbench (132); creating a rules file (134); based on the rules, generating a verification environment(s) including one or more components and creating glue logic (136); creating sequences and tests (138); linking to algorithmic test generation (140), such as one for stimuli tests; and achieving coverage closure (142).

The task 134 is implemented with the rules file 102 of FIG. 1. The tasks 136-142 are implemented by the translator 104 and the verification environment 108 generated by the translator 104 of FIG. 1.

The task (14) of creating the detailed testplan shown in FIG. 1 is replaced with the task (134) of creating the rules file. As a result, the manual task (16) of creating environment shown in FIG. 1 is replaced with the automatic process (136) of generating environment(s) and creating glue logic based on the rules. By using the system 100 of FIG. 1, the task (16) of creating the environment shown in FIG. 1, especially with a complete set of constraints and a comprehensive coverage model are eliminated.

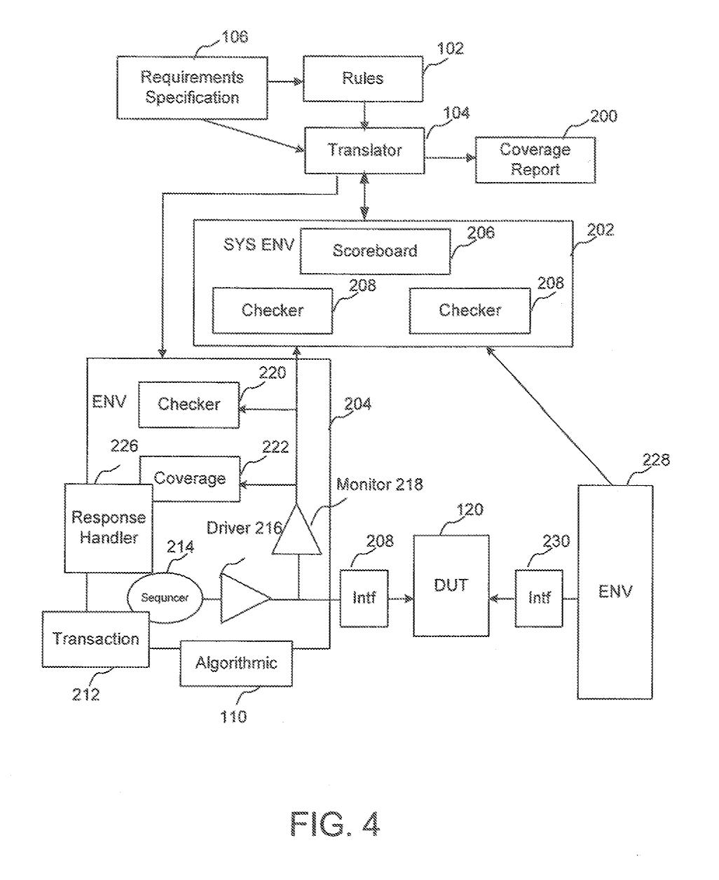

Referring to FIG. 4, there is illustrated an example of verification architecture with the system 100 and the DUT 120 shown in FIG. 1. In FIG. 4, the translator 104 converts the rules in the rules file 102 into, for example, but not limited to, a coverage report including executable testplan 200, a system level environment 202, and an interface module 204. The coverage report 200 includes executable testplan. Here the function of a testplan is covered by the coverage report 200.

The system level environment 202 includes one or more scoreboards 208 and one or more checkers 210, which interacts with the translator 104.

The interface module 204 includes one or more transactions 212, one or more sequencers 214, one or more drivers 216, one or more monitors 218, one or more checkers 220, one or more coverage monitors 222, one or more response handlers 226, and one or more SystemVerilog interfaces 228. Each component may be generated for one design. These components are operatively connected to the DUT 120 via one or more interfaces 230.

A link is created via verification code in the interface module 204 to the algorithmic engine 110 for generating stimulus, as opposed to the constrained random components generated directly from the rules file.

The rules file 102 is written in the declarative, rules based metalanguage that comprises the merging of derivatives of two languages. In a non-limiting example, one is Bakus Naur Form (BNF) which is used to describe computer language syntax. The hierarchy structure afforded by this language is used to define the hierarchy of the rules within the declarative language. The second language is a functional expression language which defines each requirement as a logical expression.

The translator 104 generates the transactions 212 which are classes that encapsulate a number of variables that can be randomized. The randomization is controlled by a set of constraints contained within the transactions 212. The rules are analyzed in an analyzer, which may be in the translator 104, and are used to generate a comprehensive set of constraints for the variables in the transactions 212. An example of a constraint generated from a rule is given below:

constraint c_tag {
(tag inside {[0:31]});
}

This constraint “constraint c_tag” is generated from a rule in the rules file 102 that restricts the range of value for the variable tag to between 0 and 31. It would be appreciated by one of ordinary skill in the art that the range between 0 and 31 is an example only, and the range of value for constraint c_tag is not limited to 0 to 31.

The rules in the rules file 102 are also analyzed looking for dependencies between variables in order to generate a set of variable randomization order constraints. An example of a generated order constraint is given below.

constraint c_fmt_type_before_td {
solve fmt_type before td;
}

The order constraints including “c_fmt_type_before_td” control the order in which the variables are randomized. This helps the constraint solver in the target language to resolve the constraints. In this case, the variable fmt_type is randomized before td since the analyzer in the environment discovered that, somewhere in the full body of rules, the variable td is dependent on the value of fmt_type.

For rules that employ an error keyword, the constraint used for generation includes code to cause the error data to be generated. An example of a generated constraint capable of inserting errored data is given below.

```
constraint c_tag {
        if (! tlp_trans_cfg.extended_tag_en) {
          if (error_code != tag_error) {
            (0 <= tag && tag <= 31)
          }
          else {
            !( (0 <= tag && tag <= 31) )
          }
        }
        else {
          (tag inside {[0:255]})
        }
}
```

In this example, when error code is not set to tag error, the variable tag is set in the range of 0 to 31. When it is set to tag error, the variable tag is set outside the range 0 to 31. It also shows the case where the rule contains a conditional clause, here defined by a config bit tlp_trans_cfg.extended_tag_en. When it is set, the range of tag is set between 0 and 255. It would be appreciated by one of ordinary skill in the art that the range between 0 to 31 is an example only, and the range of variable tag is not limited to the range of 0 to 31.

More than one level of error definition is provided where the most detailed level is used to generate constraints, and the highest level would match the system level error reporting of the DUT 120. The rules in the rules file 102 are configured so that the mapping between the detailed level and the higher levels remains consistent.

The translator 104 also generates the coverage model 222. Here the rules in the rules file 102 are analyzed to derive a comprehensive set of coverpoints. Manually created coverage models tend to oversimplify the coverage points and use crosses to expand the coverage space. This manual process tends to create a number of holes in the coverage model which could never be filled. The rules based coverage model 222 comprises targeted coverpoints, one for each rule. An example of a coverpoint generated from a rule that includes an error keyword is given below.

```
tlp_request_cfg_th_0 : coverpoint th iff ( fmt_type == CFG ) {
        bins th_0 { 0 };
        illegal_bins illegal_others[ ] = default;
}
```

In this example, the coverpoint covers the value of the variable th when the variable fmt_type is set to CFG. In this example, the value of the is restricted to zero. If it falls outside that value, then the illegal bin illegal_others is triggered, signaling that an error has occurred.

In a non-limiting example, two covergroups or models can be generated for the coverage model 222. One of the coverage models is for “master” which includes the coverage of both valid and invalid transactions sent to the DUT 120 to verify the DUT's handling of invalid input. The second coverage model is for “slave” which covers only valid transactions; invalid transactions fall into illegal bins as shown and would cause the test to fail.

The translator 104 generates the checker 220 that would test the variable and then log an error in the error code if an error is detected. An example of a check is given below.

```
if ((fmt_type == CFG) && !(th == 0 }) begin
        error_code = Malformed;
        sec_error_code = th_not_zero_when_CFG;
end
```

In this example when the variable fmt_type is CFG then the variable th needs to be zero. When it is not zero, the error code flag is set to the value given by the literal Malformed and the secondary sec error code flag is set to the value given by the literal th not zero when CFG. The error check contained in the if statement could be different from the stimulus. A construct in the language (or syntax sugar) may be used to support the independent generation of constraints for stimulus and the checks 220.

In a non-limiting fashion, each check can be wrapped in an assertion, providing an alternate reporting method for checks. Also the firing of assertions would provide information valuable to the debugging process as they indicate what and when errors occur. They also reduce the complexity of the coverage model since checking is now decoupled from coverage.

The translator 104 generates the response handler 226. The rules direct how an ingress transaction (i.e., the request to the DUT 120) is transformed to an egress transaction (i.e., the response from the DUT 120). An example is presented which shows the implementation of a Finite State Machine (FSM) derived from a rules base. The generated code would contain the following.

Configuration_Idle:

```
begin
        // <Configuration_Idle_idle_sym>
        send_idle_data = 1;
        // <Configuration_Idle_linkup1>
        LinkUp = 1;
        // <Configuration_Idle_l0>
        if (all_IDLE_data) begin
            state = L0;
        end
        // <Configuration_Idle_recoveryrlock>
        else if ((timer_done) && (idle_to_rlock_transitioned < hff))
        begin
            state = Recovery_RcvrLock;
        end
        // <Configuration_Idle_detect>
        else begin
            state = Detect;
        end
end
```

This is one case, Configuration Idle, of a much larger case statement which covers many cases, one for each state. It shows command generation: send idle data=1; variable transformation: LinkUp=1; and state change: state=L0.

The rules in the rules file 102 also provide for the generation of one or more system level coverage models with a comprehensive set of coverage items to allow the system to measure the responses provided by the DUT 120. The generation of the system level coverage models can be done with a standalone set of rules or as part of a scoreboard 206. The scoreboard 206 component compares responses from the DUT 120 against expected responses. The rules direct how the responses are compared. The rules can be used to generate a coverage model at this level.

The target language supports class hierarchy, so the translator 104 handles a module which includes a base transaction class and a number of derived classes. An example shows a base transaction tlp_trans and a derived class tlp_mem_trans.

```
class tlp_trans extends ovm_sequence_item;
        // Variable: fmt_type
        //
        // TLP format field
        rand bit [7:0] fmt_type;
        // Variable: tc
        //
        // TLP traffic class field
        rand bit [2:0] tc;
...
class tlp_mem_trans extends tlp_trans;
        // Variable: steertag
        //
        // TLP steering code
        rand bit [15:0] steertag;
        // Variable: ph
        //
        // TLP processing hints field
        rand bit [1:0] ph;
...
```

These two transactions tlp_trans and tip_mem_trans are generated from a single rules description. Both are contained in the one rules description and are generated together. The base class contains all the variables common to all the derived classes of which tlp_mem_trans is one. tlp_mem_trans adds steertag, ph, etc., variables unique to tlp_mem_trans.

The rules based language is comprehensive enough to generate the simple drivers 216, the monitors 218, and the SystemVerilog interface 228. Special predefined functions can be used to provide support for these components as well as a special mapping function which would provide connection syntax. The rules based language provides facilities to generate the environment 204 (env). The environment 204 is a container class which combines the lower level components into a single unit.

The translator 104 generates the executable testplan and coverage report 200. Here the executable testplan is linked to the requirement specification 106 using ruleids. This is a straightforward process since the rules are derived directly from the requirements. In a non-limiting example, there is an one-to-one connection between requirement and rule, however many-to-one is also common. The generated coverage model 200 support one-to-one, one-to many or many-to-one connection between requirements and rules.

For example, both a valid transaction requirement in the requirements specification 106 and an invalid transaction requirement can be linked to the same rule since rules define valid transactions and hence invalid transaction rules can be derived from the valid rule. The requirements specification 106 can be in a variety of formats: plain text, Word, or spreadsheet and converted to the target Executable testplan format. Multiple formats are supported depending upon the underlying methodology: OVM, VMM, etc; and vendor.

The rules can be considered to provide a MBFL (Mathematics Based Formal Language) description of each requirement or feature, which can be embedded in the testplan spreadsheet. This ultimately ties the coverage generated to specific testplan items and reduces the amount of post-processing needed to generate a meaningful coverage number.

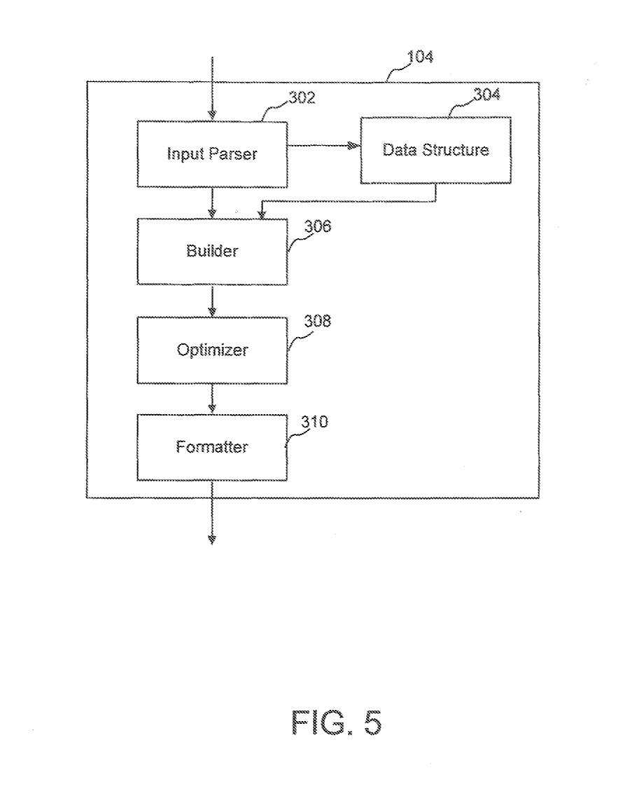

Referring to FIG. 5, there is illustrated an example of the translator shown in FIGS. 1 and 4. The translator 104 of FIG. 5 includes an input parser 302, a builder 306, an optimizer 308, and a formatter 310. The input parser 202 reads the input rules text and fills internal data structures 304. The builder 306 uses the data in the data structures 304 to generate the verification and system components. The code is optimized using the optimizer 308. The code is then formatted using the formatter 310 into the final format.

Referring to FIGS. 1 and 3-5, it would be appreciated by one of ordinary skill in the art that the rules file 102 may be created in a computer device having a user interface, a processor and a memory, and the translator 104 may be implemented with a computer's processor with a memory.

According to the embodiments of the present disclosure, since the environment is mostly generated, the tasks left for the verification engineer is that of developing temporal components and the writing of tests and sequences used by the tests. This is where the work of verification is done. The view is temporal in nature and is not accommodated in the rules file 102 written by the rules based language.

Being a rules based system, the system 100 is linked to other existing rules based systems such as rules based algorithmic stimulus generation 110 as described by US Patent Application Publication No. 2005/0071720 by Kadkade, et al. The benefit of the rules based metalanguage approach taken in the system 100 over the current algorithmic approach is that it can support both random stimulus generation which reveals unexpected behaviours of the DUT 120 and also the algorithmic approach. The algorithmic approach leads to closing coverage more quickly than random techniques using a more directed tack.

According to the embodiments of the present disclosure, comments attached to rules can be replicated in the verification components for documentation purposes. The formatting of the comments in the target components is to allow for the generation of on-line documentation using documentation systems such as NaturalDocs or Doxygen. Such on-line documentation is valuable for building the understanding of the operation of all the components in the verification environment with the rest of the verification team. The example given for base and derived transactions shows code that includes comments which support the generation of NaturalDocs on-line documentation.

The embodiments described herein may include one or more elements or components, not illustrated in the drawings. The embodiments may be described with the limited number of elements in a certain topology by way of example only. Each element may include a structure to perform certain operations. Each element may be implemented as hardware, software, or any combination thereof. The data structures and software codes, either in its entirety or a part thereof, may be stored in a computer readable medium, which may be any device or medium that can store code and/or data for use by a computer system. Further, a computer data signal representing the software code which may be embedded in a carrier wave may be transmitted as an electrical or optical signal, which may be conveyed via electrical or optical cable or by radio or other means.

What is claimed is:

1. A method of generating a verification environment, comprising:
at least one of describing, organizing, analyzing and receiving a set of rules with a metalanguage, for verifying performance of a design under test (DUT); and
converting the rules written in the metalanguage to verification code implementing the verification environment operably coupling to the DUT.

2. The method of claim 1, wherein the metalanguage is a declarative language.

3. The method of claim 1, wherein the metalanguage is used to define the set of rules to generate the verification environment associating with a verification methodology which includes Open Verification Methodology (OVM).

4. The method of claim 1, comprising:
translating the description in the metalanguage into a verification language.

5. The method of claim 4, wherein the verification language comprises SystemVerilog or SystemC.

6. The method of claim 1, wherein each rule is linked to a requirement for a hardware corresponding to the DUT, by a rule identification.

7. The method of claim 1, wherein the set of rules comprises rules for at least one of:
generating at least one constraint for variables for a constrained random simulation;
generating a target extendable testplan for a design;
generating at least one of components for checking and collecting coverage information for the design;
linking at least a part of the generated components to a algorithmic component;
checking coverage information separately from stimulus generation;
error handling; and
generating non-temporal verification code linking to a simulator.

8. The method of claim 1, wherein the metalanguage contains multiple rule descriptions to independently support stimulus generation and response checking.

9. The method of claim 1, wherein the metalanguage supports the automatic handling of errors:

10. The method of claim 9, wherein the handling of errors comprises at least one of:
error injection of stimulus, and
error checking and reporting of a response.

11. The method of claim 6, wherein the rules comprise a rule to generate an executable testplan from a requirement in the specification, the requirement being linked to the rule by a unique identification.

12. The method of claim 11, wherein the rules can be embedded in the executable testplan.

13. The method of claim 1, wherein the rules written in the metalanguage supports other rules based methodologies including algorithmic stimulus generation.

14. The method of claim 7, where the verification environment comprises:
one or more coverage models with a comprehensive set of coverage items.

15. The method of claim 7, wherein said constraints comprise:
constraints to order the randomization of variables which is determined by analyzing dependencies between variables.

16. The method of claim 14, wherein the coverage model supports at least one of a one-to-one, a one-to-many and a many-to-one correspondence between the rules and requirements.

17. The method of claim 7, wherein the verification environment comprises at least one of:
one or more checkers, and
one or more scoreboards.

18. The method of claim 17, wherein the checker comprises:
an information field annotated to report any detected error, or
assertions that are used to report any detected error.

19. The method of claim 7, wherein the verification environment composes:
one or more models.

20. The method of claim 19, wherein the verification environment composes:
one or more models that can be used to implement response handlers, and
one or more models that can be used to implement Finite State Machines.

21. The method of claim 7, wherein comments placed in the rules are added to the generated components providing for on-line documentation using a documentation system.

22. The method of claim 21, wherein the documentation system comprises at least one of NaturalDocs and Doxygen.

23. A non-transitory computer readable storage medium storing one or more programs, the one or more programs comprising instructions, which when executed by a computer device, cause the computer device to perform a method of generating a verification environment, the method comprising:
at least one of describing, organizing, analyzing and receiving a set of rules with a metalanguage, for verifying performance of a design under test (DUT); and
converting the rules written in the metalanguage to verification code implementing the verification environment operably coupling to the DUT.

24. A system for generating a verification environment, comprising:
a rules file comprising a set of rules written in a metalanguage to describe the verification environment for verifying performance of a design under test (DUT); and
a translator for converting the rules written in the metalanguage to verification code implementing the verification environment operably coupling to the DUT.

25. A system of claim 24, comprising:
a processor; and
computer readable storage medium storing one or more programs, the one or more programs comprising instructions, which when executed by the processor, cause the processor to:
convert rules in a rules file written in a metalanguage to verification code implementing the verification environment operably coupling to a design under test (DUT).

26. A system of claim 24, comprising:
a processor; and
computer readable storage medium storing one or more programs, the one or more programs comprising instructions, which when executed by the processor, cause the processor to:
describe, organize or receiving a set of rules in a rules file written in a metalanguage to verification code implementing the verification environment operably coupling to a design under test (DUT); and
analyzing the set of rules.

27. A method of verification of a design under test (DUT), comprising:
analyzing rules written in a metalanguage to convert the rules into verification code implementing a verification environment operably coupling to the DUT; and
linking the verification code to an algorithmic test generation
